(19) United States
(12) Patent Application Publication
(10) Pub. No.: US 2006/0290288 A1
(43) Pub. Date: Dec. 28, 2006

(54) Field emission display and manufacturing method thereof

(76) Inventors: Jun-Hee Choi, Suwon-si (KR); Andrei Zoulkarneev, Suwon-si (KR)

Correspondence Address: ROBERT E. BUSHNELL, 1522 K STREET NW, SUITE 300, WASHINGTON, DC, 20005-1202, US

(21) Appl. No.: 11/151,216

(22) Filed: Jun. 14, 2005

(51) Int. Cl. G09G 3/10

(52) U.S. Cl. 315/169.1

(57) ABSTRACT

A field emission display is provided. The field emission display includes a rear substrate, a cathode, a first dielectric layer, a gate electrode, a second dielectric layer, a deflection electrode, a third dielectric layer, and a protective electrode. The cathode is formed on the rear substrate, and an emitter is formed on the cathode. The first dielectric layer is formed on the cathode, and a first through hole corresponding to the emitter is formed in the first dielectric layer. The gate electrode is formed on the first dielectric layer, and a gate hole corresponding to the emitter is formed in the gate electrode. The second dielectric layer is formed on the gate electrode, and a second through hole corresponding to the emitter is formed in the second dielectric layer. The deflection electrode is formed on the second dielectric layer, the deflection electrode has at least two elements symmetrically arranged to face each other with the emitter therebetween, and a deflection voltage of a predetermined waveform is applied to the deflection electrode. The third dielectric layer is formed on the deflection electrode, and a third through hole corresponding to the emitter is formed in the third dielectric layer. The protective electrode is formed on the third dielectric layer, the protective electrode has a hole corresponding to the emitter, and a predetermined fixed voltage is applied to the protective electrode.

### BRIEF DESCRIPTION OF THE DRAWINGS

FIG. 1 is a sectional view illustrating a structure of a conventional field emission display.

FIG. 2 is a plan view of a cold cathode of a conventional field emission display.

FIG. 3 is a sectional view illustrating a conventional color reproduction method where emitters are in 1:1 correspondence with phosphor layers.

FIG. 4 is a sectional view illustrating a conventional color reproduction method where emitters are in 1:3 correspondence with phosphor layers.

FIG. 5 is a sectional view of a field emission display equipped with a deflection electrode according to the present invention.

FIG. 6 is a plan view of a field emission display equipped with a deflection electrode according to a first embodiment of the present invention.

FIG. 7 is a plan view of a field emission display equipped with a deflection electrode according to a second embodiment of the present invention.

FIG. 8 is a sectional view of a field emission display equipped with a deflection electrode according to a third embodiment of the present invention.

FIG. 9 is a sectional view of a field emission display equipped with a deflection electrode and a protective layer according to the present invention.

FIGS. 10A and 10B are plan views of a field emission display equipped with a deflection electrode and a protective electrode according to a fourth embodiment of the present invention.

FIG. 11 is a plan view of a field emission display equipped with a deflection electrode and a protective layer according to a fifth embodiment of the present invention.

FIG. 12 is a view illustrating a deflection voltage controlling unit according to a first embodiment of the present invention.

FIG. 13 is a view illustrating a deflection voltage controlling unit according to a second embodiment of the present invention.

FIG. 14 is a view illustrating a trajectory of an electron emitted when a voltage of an R deflection mode is applied to a deflection electrode of a field emission display equipped with the deflection electrode according to the present invention.

FIG. 15 is a view illustrating a trajectory of an electron emitted when a voltage of a G deflection mode is applied to a deflection electrode of a field emission display equipped with the deflection electrode according to the present invention.

FIG. 16 is a view illustrating a trajectory of an electron emitted when a voltage of a B deflection mode is applied to a deflection electrode of a field emission display equipped with the deflection electrode and a protective electrode according to the present invention.

FIG. 17 is an enlarged view of an area ‘A’ shown in FIG. 16.

FIGS. 18A through 18D are sectional views illustrating a manufacturing procedure for a field emission display equipped with a deflection electrode according to the present invention.

FIGS. 19A through 19E are sectional views illustrating a manufacturing procedure for a field emission display equipped with a deflection electrode and a protective electrode according to the present invention.

### EXPLANATION OF REFERENCE NUMERALS DESIGNATING THE MAJOR ELEMENTS OF THE DRAWINGS

10: rear substrate
20: cathode
30: resistive element
40: first dielectric layer
45: gate electrode
50: second dielectric layer
55: deflection electrode
551, 553: first element
552, 554: second element
60: third dielectric layer
65: protective electrode
70: photoresist
80: front substrate
85: anode
90: phosphor layer
100: emitter

### DETAILED DESCRIPTION OF THE INVENTION

### Object of the Invention

[Technical Field of the Invention and Related Art prior to the Invention]

The present invention relates to a field emission display, and more particularly, to field emission display and a manufacturing method thereof, which deflects an electron beam by providing a deflection electrode on a rear substrate on which a cold cathode is formed, and improves its reliability by providing a protective electrode on an uppermost layer of the rear substrate.

Generally, a field emission display applies an electric field from a gate electrode to emitters arranged on a cathode to be spaced apart from one another by a predetermined interval to thereby cause the emitters to emit electrons, and collides the emitted electrons against a phosphor layer on an anode to which a high voltage is applied to thereby cause the phosphor layer to emit light.

FIG. 1 is a sectional view illustrating a structure of a conventional field emission display. Referring to FIG. 1, in the conventional field emission display, a cathode 20 is provided on a rear substrate 10, and a first dielectric layer 40 and a metal gate electrode 45 are sequentially deposited on the rear substrate 10. A gate hole 45A and a first through hole 40A are respectively formed in the gate electrode 45 and the first dielectric layer 40 in such a way that they communicate with each other. The cathode 20 is partially exposed at the bottom of the first through hole 40A, and an emitter 100 (that is, an electron emission source) is formed on the exposed cathode 20. The emitter 100 may be formed through the growth or deposition of a carbon nanotube (CNT) 101.

A cold cathode device in the above structure is formed on the rear substrate 10, and a front substrate 80 is installed in front of the rear substrate 10 in such a way to be spaced apart from the cold cathode device by a predetermined distance. An anode 85, to which a high voltage is applied, is provided on a rear surface (that is, a surface facing the rear substrate 10) of the front substrate 80, and a phosphor layer 90 is provided on the anode 85.

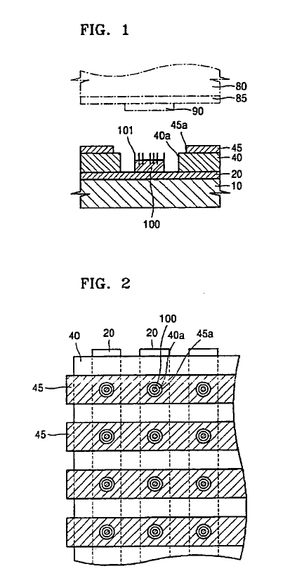

FIG. 2 is a plan view of a cold cathode of a conventional field emission display. Referring to FIG. 2, cathodes 20 are formed on a substrate (not shown) in parallel stripes, a first dielectric layer 40 is formed on the cathodes 20, and gate electrodes 45 are formed on the first dielectric layer 40 in parallel stripes perpendicular to the cathodes 20.

Gates hole 45A and first through holes 40A are formed at positions where the cathodes 20 and the gate electrodes 45 intersect each other, and emitters 100 are formed at the bottoms of the first through holes 40A. Generally, a data voltage is applied to each cathode 20, and a scanning voltage is applied to each gate electrode 45.

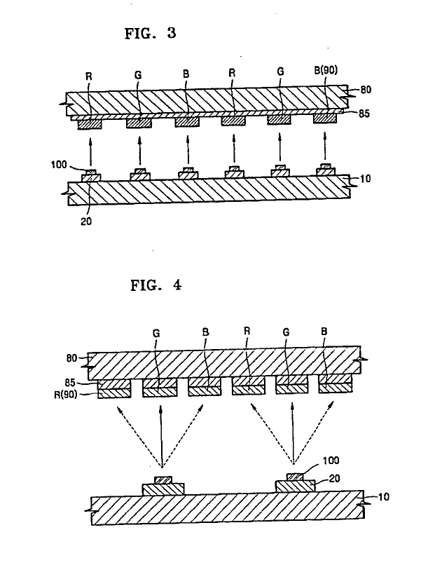

FIG. 3 is a sectional view illustrating a conventional color reproduction method where emitters are in 1:1 correspondence with phosphor layers. Referring to FIG. 3, when RIG/B phosphor layers constitute one pixel, R/G/B subpixels each correspond to each emitter 100.

While this method can lower a frame frequency, it has drawbacks in that the size of the emitter 100 is reduced and the width of a data line for applying a data voltage to the emitter 100 is narrowed. Increased data line resistance due to the narrowed data line width tends to cause a problem when a high resolution image is reproduced.

To solve the problem caused by the increased data line resistance, there has been proposed a method of exciting three subpixels by one emitter.

FIG. 4 is a sectional view illustrating a conventional color reproduction method where emitters are in 1:3 correspondence with phosphor layers. Referring to FIG. 4, RIG/B phosphor layers 90 constitute one pixel, and one emitter 100 corresponds to one pixel. Three anodes 85 are respectively provided on the bottoms of the R/G/B phosphor layers 90, and a high voltage is alternately applied to the three anodes 85, whereby an electron beam is attracted to each phosphor layer.

However, while this method can provide a data line width three times larger than that in the method shown in FIG. 3, it undesirably has an increased frame frequency three times larger than that in the method shown in FIG. 3 because it must reproduce respective R/G/B signals so as to reproduce one frame image. Specifically, a residual voltage tends to be generated in the anodes because a high voltage of up to several kV must be switched in the anodes at a high frequency. In this case, a part of electron beams is transferred toward a neighboring phosphor layer, whereby color purity is degraded. When a voltage of the anode is lowered to prevent the degradation of color purity, a luminance may be degraded.

[Technical Goal of the Invention]

The present invention provides a field emission display and a manufacturing method thereof, which can deflect an electron beam with a relatively-low voltage by providing a deflection electrode capable of adjusting the direction of the electron beam on a rear substrate, and can improve its reliability by providing a protective layer on an uppermost layer of the rear substrate.

[Structure and Operation of the Invention]

According to an aspect of the present invention, there is provided a field emission display including: a rear substrate; a cathode formed on the rear substrate, an emitter being formed on the cathode; a first dielectric layer formed on the cathode, a first through hole corresponding to the emitter being formed in the first dielectric layer; a gate electrode formed on the first dielectric layer, a gate hole corresponding to the emitter being formed in the gate electrode; a second dielectric layer formed on the gate electrode, a second through hole corresponding to the emitter being formed in the second dielectric layer; a deflection electrode formed on the second dielectric layer, the deflection electrode having at least two elements symmetrically arranged to face each other with the emitter therebetween, a deflection voltage of a predetermined waveform being applied to the deflection electrode; a third dielectric layer formed on the deflection electrode, a third through hole corresponding to the emitter being formed in the third dielectric layer; and a protective electrode formed on the third dielectric layer, the protective electrode having a hole corresponding to the emitter, a predetermined fixed voltage being applied to the protective electrode.

The emitter may be formed through the growth of a CNT or the coating of CNT paste. The deflection electrode may deflect an electron beam emitted from the emitter by a symmetrical or asymmetrical electric filed.

A predetermined low voltage may be applied to the protective electrode, whereby the electron beam can be focused without being dispersed and positively-charged particles can be prevented from being accumulated in a vacuum space of the field emission display.

According to another aspect of the present invention, there is provided a field emission display including: a rear substrate; a cathode formed on the rear substrate in parallel stripes, an emitter being formed on the cathode to be spaced apart from one another by a predetermined interval; a first dielectric layer formed on the cathode, a first through hole corresponding to the emitter being formed in the first dielectric layer; a gate electrode formed on the first dielectric layer in parallel stripes intersecting the parallel stripes of the cathode, a gate hole corresponding to the emitter being formed in the gate electrode; a second dielectric layer formed on the gate electrode, a second through hole corresponding to the emitter being formed in the second dielectric layer; a deflection electrode formed on the second dielectric layer in such a way to Intersect the gate electrode and correspond in parallel with the cathode, the deflection electrode having at least two elements symmetrically arranged to face each other with the emitter therebetween, a deflection voltage of a predetermined waveform being applied to the deflection electrode; a third dielectric layer formed on the deflection electrode, a third through hole corresponding to the emitter being formed in the third dielectric layer; and a protective electrode formed on the third dielectric layer, the protective electrode having a hole corresponding to the emitter, a predetermined fixed voltage being applied to the protective electrode.

Here, one emitter formed on the rear substrate may correspond to one pixel constituted by subpixels of various colored phosphor layers formed on a front substrate. The brightness of each pixel may be determined through combinations of a voltage applied to the cathode and a voltage applied to the gate electrode. That an electron beam will cause what color subpixel to emit light may be determined by a voltage applied to the deflection electrode.

The field emission display may include a deflection voltage controlling unit for adjusting a voltage applied across the deflection electrode, and a front substrate disposed to be spaced apart from the rear substrate by a predetermined distance. An anode may be formed on the front substrate's surface facing the rear substrate, and various colored parallel phosphor layers may be formed on the anode.

The deflection voltage controlling unit may apply voltages of several deflection modes to the deflection electrode. The direction of an electron beam emitted from the emitter may be adjusted through combination of voltages according to the respective deflection modes. Accordingly, an electron beam according to each deflection mode may be transferred to a corresponding colored phosphor layer formed on the anode of the front substrate.

The pixel may be constituted by R/G/B parallel subpixels disposed on the anode. The deflection voltage controlling unit may cause electron beams of the same brightness signal to be sequentially transferred to the R/G/B subpixels, whereby a desired color image can be formed by the resulting afterimage.

According to a further aspect of the present invention, there is provided a method for manufacturing a field emission display, the method including: forming a cathode of a predetermined pattern on a rear substrate, sequentially depositing a resistor layer, a first dielectric layer and a first metal layer on the cathode, and then forming a gate electrode by patterning the first metal layer; sequentially depositing a second dielectric layer and a second metal layer on the gate electrode, and then forming a deflection electrode by patterning the second metal layer, forming an emitter hole through an etching process so that the cathode is exposed at a position where the emitter is to be formed; and forming an emitter in the emitter hole by using a carbon nanotube.

According to a still further aspect of the present invention, there is provided a method for manufacturing a field emission display, the method including: forming a cathode of a predetermined pattern on a rear substrate, sequentially depositing a resistor layer, a first dielectric layer and a first metal layer on the cathode, and then forming a gate electrode by patterning the first metal layer, sequentially depositing a second dielectric layer and a second metal layer on the gate electrode, and then forming a deflection electrode by patterning the second metal layer, sequentially depositing a third dielectric layer and a third metal layer on the deflection electrode, and then forming a protective electrode by patterning the third metal layer; forming an emitter hole through an etching process so that the cathode is exposed at a position where the emitter is to be formed; and forming an emitter in the emitter hole by using a carbon nanotube.

The present invention will now be described more fully with reference to the accompanying drawings, in which exemplary embodiments of the invention are shown. Like reference numerals in the drawings denote like elements, and thus their description will be omitted.

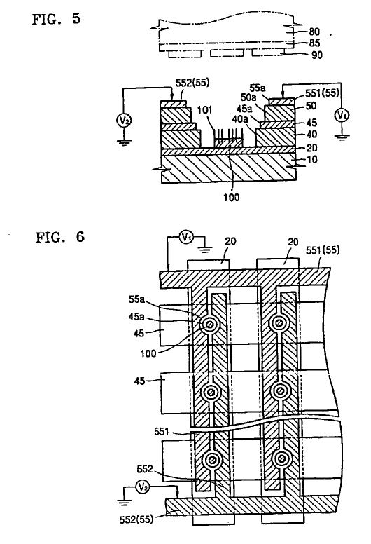

FIG. 5 is a sectional view of a field emission display equipped with a deflection electrode according to the present invention. Referring to FIG. 5, the inventive field emission display includes a rear substrate 10 on one side of which a cold cathode device is formed, and a front substrate 80 arranged to be spaced apart from the rear substrate 10 by a predetermined distance. A space between the rear substrate 10 and the front substrate 80 is maintained in a vacuum state.

The inventive field emission display further includes a cathode 20 formed on the rear substrate 10, an emitter 100 formed of a carbon nanotube, a gate electrode 45 formed on the cathode 20 in such a way to be isolated from the cathode 20, and a deflection electrode 55 formed on the gate electrode 45.

The deflection electrode 55 includes at least two elements facing each other with the emitter 100 between them. When one deflection axis is necessary for controlling the direction of an electron beam, the deflection electrode 55 may be constituted by first and second elements.

A voltage V1 and a voltage V2 are applied respectively to first element 551 and second element 552 of the deflection electrode. When V1 equals V2, a symmetrical electric field is formed in an emitter hole, whereby an electron beam emitted from the emitter 100 travels straight. On the contrary, when V1 differs from V2, an asymmetrical electric field is formed in the emitter hole, whereby the electron beam emitted from the emitter 100 is deflected to one side.

Meanwhile, an anode 85 is formed on the front substrate 80's surface facing the rear substrate 10, and parallel phosphor layers 90 of various colors are formed on the anode 85. Accordingly, to cause an electron beam (deflected by the deflection electrode 55) to reach one of the phosphor layer of an cause a phosphor layer of a desired color to emit light.

Here, the phosphor layers 90 may be constituted by R/G/B subpixels, and one pixel constituted by three subpixels may correspond to one emitter 100.

FIG. 6 is a plan view of a field emission display equipped with a deflection electrode according to a first embodiment of the present invention, which illustrates a portion of a cold cathode device formed on a rear substrate with a dielectric layer being omitted for simplicity.

Referring to FIG. 6, cathodes 20 and gate electrodes 45 are formed in intersected stripes, emitters 100 are formed on the cathodes 20 at intersected positions of the stripes, and deflection electrodes 55 are formed on the gate electrodes 45 in such a way to be parallel with the cathodes 20.

Two elements of the deflection electrode 55 are symmetrically arranged to face each other with the emitter 100 between them. Here, first elements 551 of deflection electrodes passing by the left side of the emitter 100 are connected with one another, and second elements 552 of deflection electrodes passing by the right side of the emitter 100 are connected with one another. A voltage V₁ and a voltage V₂ are applied respectively to the first element 551 and the second element 552, and the direction of an electron beam can be adjusted as described above.

The deflection electrodes 55 have arc portions at their inner sides and arranged to surround the emitter 100 through the arc portions, whereby an average gap between the deflection electrodes 55 and the emitter 100 can be reduced. The magnitude of the voltages applied to the deflection electrodes 55 are set in consideration of signal voltages applied to the cathode 20 and the gate electrode 45 and a distance between it and an anode. When V₁ and V₂ are all minus, the deflection electrodes 55 can simultaneously function as focusing gates because they have the arc portions surrounding the emitter 100.

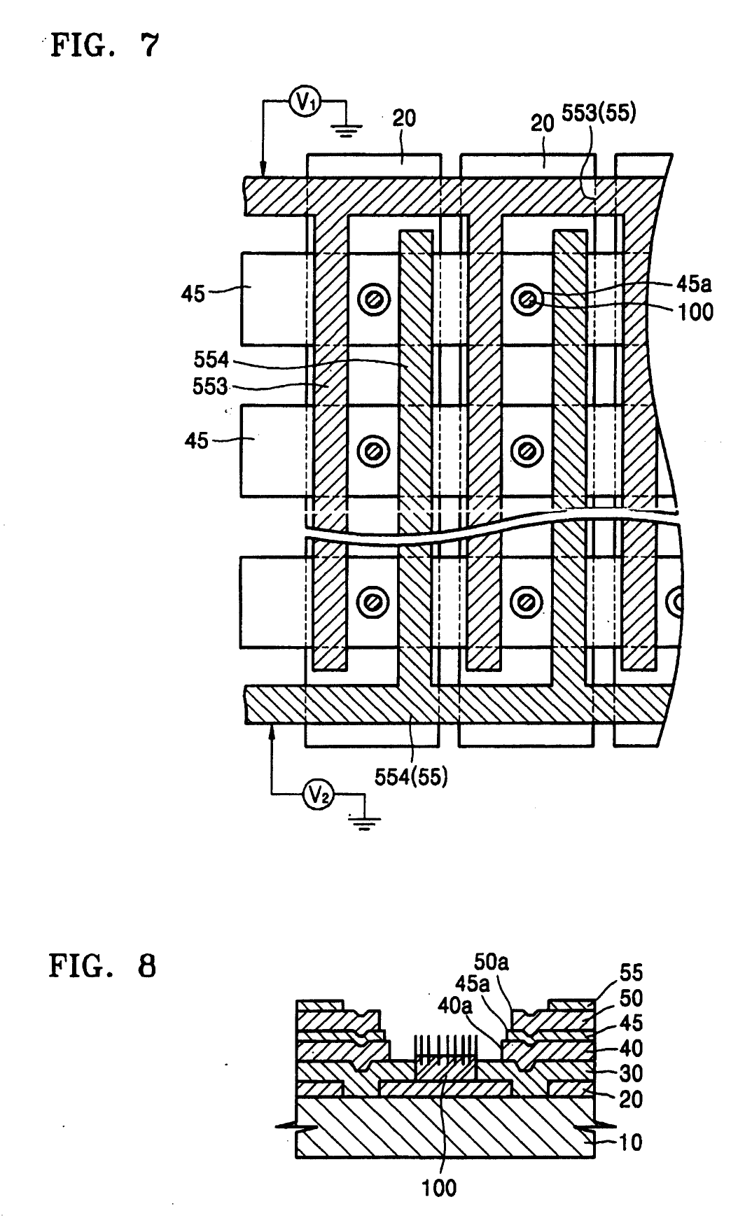

FIG. 7 is a plan view of a field emission display equipped with a deflection electrode according to a second embodiment of the present invention, which illustrates a portion of a cold cathode device including a cathode, a gate electrode and a deflection electrode on a rear substrate with a dielectric layer being omitted for simplicity. Referring to FIG. 7, the second embodiment is substantially the same as the first embodiment with the exception that the shape of a deflection electrode 55 in the second embodiment is different from that in the first embodiment. That is, in the second embodiment, a first element 553 of the deflection electrode and a second element 554 of the deflection electrode are respectively formed at both sides of the emitter hole in a straight-line shape. It should be noted that the deflection electrode 55 may have shapes other than those in the first and second embodiments.

FIG. 8 is a sectional view of a field emission display equipped with a deflection electrode according to a third embodiment of the present invention. Referring to FIG. 8, in the third embodiment, a resistive element 30 is further provided between the cathode 20 and a first dielectric layer 40, whereby electrons supplied from the cathode 20 can be transferred uniformly to the whole emitter 100. The resistive element 30 functions as a ballast resistor, and makes it possible to prevent the shortening of a lifetime of the emitter 100 that may be caused by intensive emission of electrons from the tips of a part of carbon nanotubes.

These features of the above embodiments can be applied to other embodiments of the present invention.

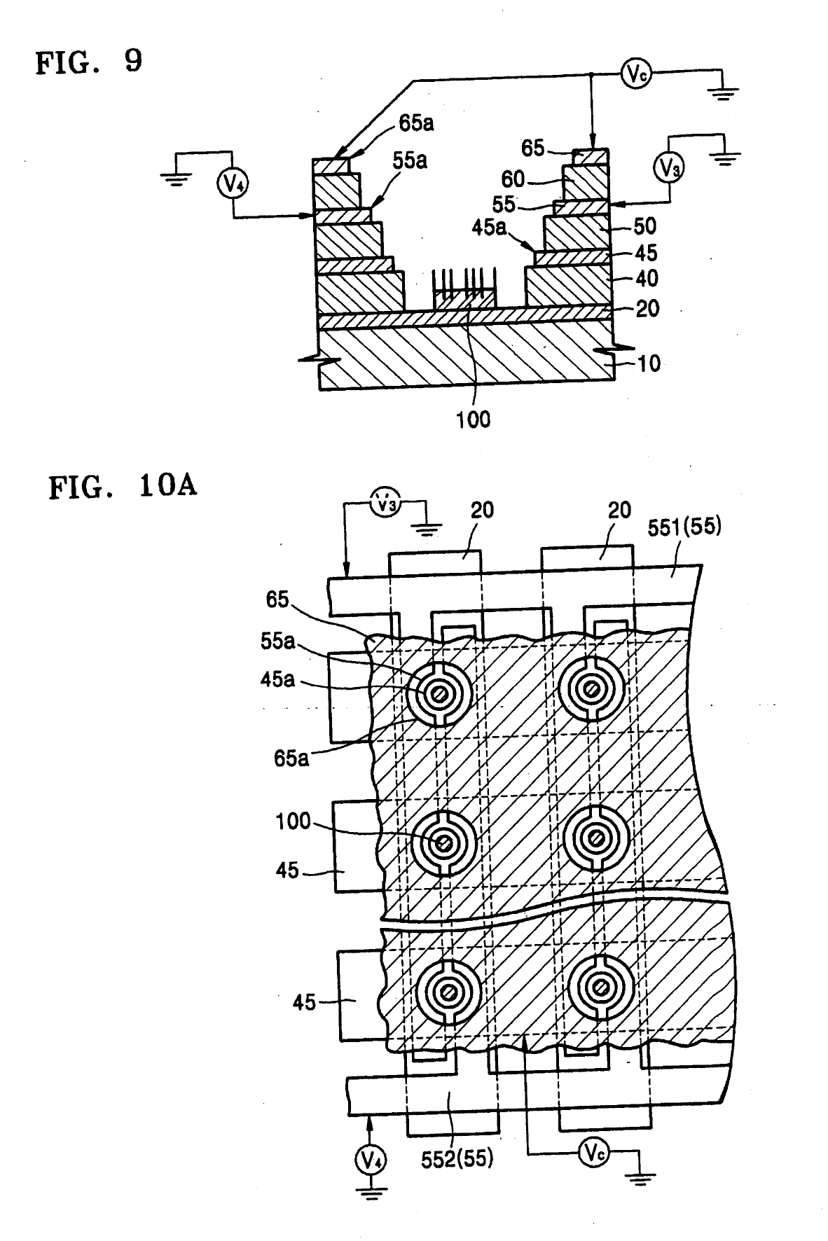

FIG. 9 is a sectional view of a field emission display equipped with a deflection electrode and a protective electrode according to the present invention. Referring to FIG. 9, an inventive field emission display includes a third dielectric layer 60 formed on a deflection electrode 55, and a protective electrode 65 formed on the third dielectric layer 60. A third through hole communicating with the first and second through holes is formed in the third dielectric layer 60, and the protective electrode 65 is patterned to have a hole 65A corresponding to the third through hole.

A predetermined low voltage Vc is applied to the protective electrode 65. Accordingly, an electron beam deflected by the deflection electrode 55 can reach a targeted subpixel without being dispersed. Voltages V₃ and V₄ applied to the deflection electrode 55 may be identical to or different from each other according to whether or not the electron beam has been deflected, and may be concretely determined according to the relationships among them and Vc and a gate electrode voltage.

FIG. 10A is a plan view of a field emission display equipped with a deflection electrode and a protective layer according to a fourth embodiment of the present invention, which illustrates a portion of a cold cathode device formed on a rear substrate with an dielectric layer being omitted for simplicity.

Referring to FIG. 10A, in the fourth embodiment, a third dielectric layer (not shown) is formed on a deflection electrode 55, and a protective electrode 65 is formed on the third dielectric layer. The protective electrode 65 may be formed in a body with respect to the whole surface of the cold cathode device. A hole 65A is formed at a position corresponding to each emitter, whereby the same structure as a general focusing gate is obtained.

As described above, the protective electrode 65 to which a low voltage Vc is applied can function as a focusing gate. In addition, the protective electrode can prevent the accumulation of positively-charged particles generated at an vacuum space in the field emission display. Accordingly, the protective electrode 65 can protect the field emission display from various problems that may be caused by static electricity of high voltage.

In a general field emission display, a front substrate and a rear substrate are installed to be spaced apart from each other by a predetermined distance with a spacer, a circumference portion thereof is sealed, and an inner space thereof is maintained in a near vacuum state of about 10⁻⁶ through 10⁻⁵ mbar. However, since the inner space is not a perfect vacuum state, gas molecules exists in the inner space and the gas molecules is positively charged by the device's inner environment of high positive polarity. When these positively-charged particles are accumulated in a dielectric layer exposed upward and thus static charge of high voltage is formed, an arcing may be generated due to a breakdown between the accumulated charge and emitters or metal electrodes and the conductivity of a ballast resistor (that is, a semiconductor) may be changed.

In this embodiment, the protective electrode 65 is formed of a metal electrode of high conductivity, whereby the accumulation of the positive charge is prevented and thus the cold cathode device formed on the rear substrate 10 is protected.

FIG. 10B illustrates the position relationships among the above components formed on the rear substrate and R/G/B phosphor layers formed on the front substrate in the field emission display shown in FIG. 10A. Referring to FIG. 10B, a G phosphor layer is arranged at the front of an emitter to thereby receive straight-traveled electrons, and R/B phosphor layers are arranged respectively at both sides of the emitter to thereby respectively receive electrons deflected left and right by the deflection electrode 55.

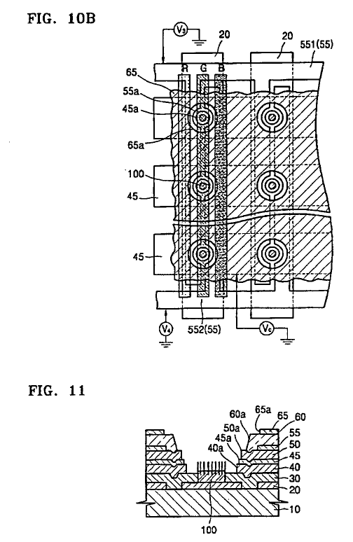

FIG. 11 is a plan view of a field emission display equipped with a deflection electrode and a protective layer according to a fifth embodiment of the present invention. Referring to FIG. 11, a ballast resistor 30 is further provided between the cathode 20 and the emitter 100 when compared with the embodiment shown in FIG. 9, whereby electrons supplied from the cathode 20 can be uniformly supplied through the ballast resistor 30 to the whole emitter 100.

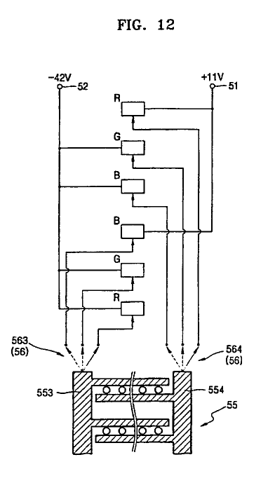

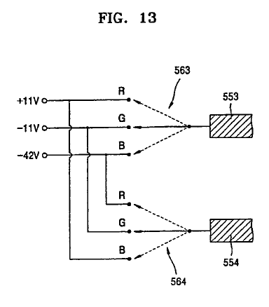

FIG. 12 is a view illustrating a deflection voltage controlling unit according to a first embodiment of the present invention. Referring to FIG. 12, voltages of three deflection modes are applied to the first and second elements 553 and 554 of the deflection electrodes, and an electron beam emitted from the emitter is transferred selectively to an R, G or B phosphor layer.

Voltages +11V and −42V are supplied respectively to two voltage input ports 51 and 52, and three combinations of output port voltages, that is, R(−42V, +11V), G(−42V, −42V) and B(+11V, −42V) are obtained through a predetermined switching circuit.

Switches 563 and 564 provided respectively to input ports of the first and second elements 553 and 554 of the deflection electrodes are sequentially connected to the three output ports, whereby the three combinations of the output port voltages are applied to the deflection electrodes. Three switching operations for each of R/G/B colors are necessary for reproducing one color. Accordingly, when a frame frequency is 60 Hz, a switch 56 is switched at the rate of 180 Hz.

The magnitude of a voltage applied to the deflection electrode 55 is determined in consideration of the voltage relationship between the gate electrode and the protective electrode. However, since generally determined within a low voltage range of about −200V through +200V, the applied voltage does not cause a problem that may be generated due to a residual voltage, even when the switch 56 is switched at the rate of 180 Hz.

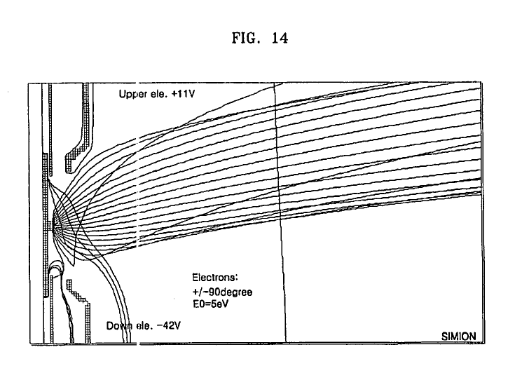

FIG. 13 is a view illustrating a deflection voltage controlling unit according to a second embodiment of the present invention. Referring to FIG. 13, combinations of voltages applied to the first and second deflection electrodes 553 and 554 can be provided in three R/G/B deflection modes as the first embodiment illustrated in FIG. 12.

FIG. 14 is a view illustrating a trajectory of an electron emitted when a voltage of an R deflection mode is applied to a deflection electrode of a field emission display equipped with the deflection electrode according to the present invention. In detail, FIG. 14 illustrates an electron trajectory simulation result when a gate voltage is 180V, an anode voltage is 2.5 kV, −42V is applied to the first deflection electrode, and +1V is applied to the second deflection electrode. It can be known from the simulation result that an electron of a negative charge is deflected toward the second deflection electrode 554 of a high voltage and then transferred to an R phosphor layer (not shown).

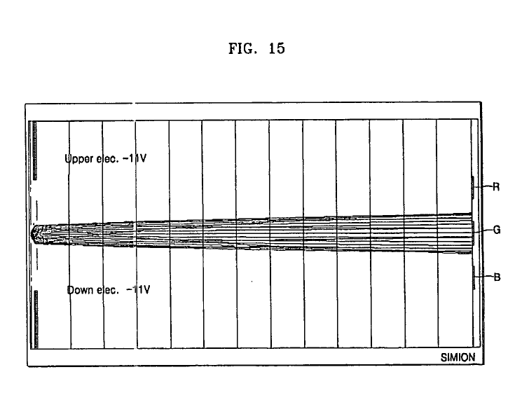

FIG. 15 is a view illustrating a trajectory of an electron emitted when a voltage of a G deflection mode is applied to the deflection electrode of a field emission display equipped with the deflection electrode according to the present invention. In detail, FIG. 15 illustrates an electron trajectory simulation result when a gate voltage is 180V, an anode voltage is 2.5 kV, and −11V is applied to the first and second elements of the deflection electrodes. It can be known from the simulation result that an electron beam is not deflected but is transferred straight to an G phosphor layer when the same voltage of −11V is applied to the first and second deflection electrodes.

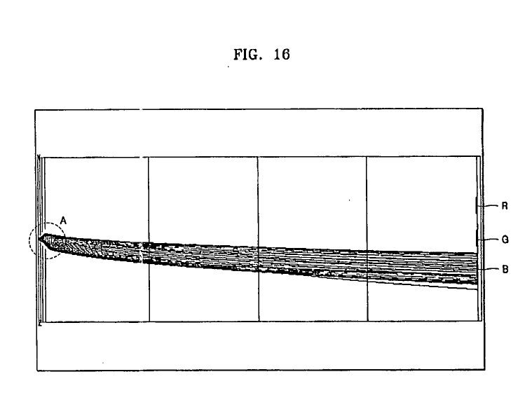

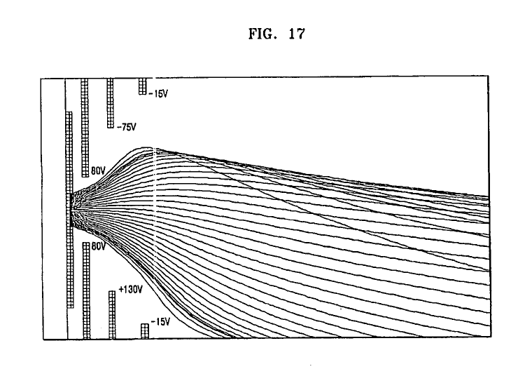

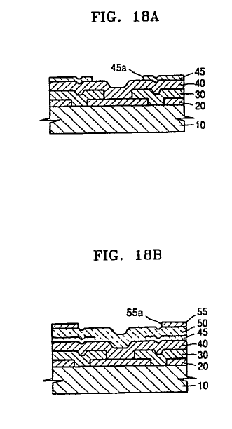

FIG. 16 is a view illustrating a trajectory of an electron emitted when a voltage of a B deflection mode is applied to a deflection electrode of a field emission display equipped with the deflection electrode and the protective electrode according to the present invention. In detail, FIG. 16 illustrates an electron trajectory simulation result when a distance between the front and rear substrates is 1500 μm, a gate voltage is 80V, an anode voltage is 2.5 kV, a voltage of the protective electrode shown in FIG. 4 is −15V, and +130V and −75V are applied respectively to the first and second elements of the deflection electrodes. It can be known from the simulation result that an electron beam emitted from the emitter is deflected toward the first element 553 of a higher voltage and then transferred to an B phosphor layer.

FIG. 17 is an enlarged view of an area ‘A’ shown in FIG. 16. Referring to FIG. 17, a trajectory of an electron traveling at the left side is deflected toward the first element of a high voltage +130V and then focused at the center side without being dispersed by the protective electrode (−15V). In this manner, the protective electrode not only can prevent the accumulation of a positive charge on a surface of the cold cathode device, but also can focus the electron beam.

In addition, the deflection voltage controlling unit can increase/decrease a voltage of one of at least two elements of the deflection electrodes by the same magnitude with respect to all the deflection modes. Accordingly, arrival positions of electron beams for all the colors can be horizontally shifted. Therefore, a possible misallignemnt between the rear and front substrates can be compensated through an electrical adjustment.

A method for manufacturing the inventive field emission display will now be described in detail.

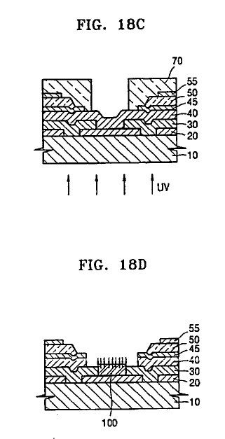

FIGS. 18A through 18D are sectional views illustrating a manufacturing procedure for a field emission display equipped with a deflection electrode according to the present invention. Referring first to FIG. 18A, a cathode ray 20 is formed on a rear substrate and then pattered. A ballast resistor layer 30, a first dielectric layer 40 and a gate electrode 45 are formed on the cathode layer 30 and then patterned.

The ballast resistor 30 may be made of material having resistivity of about 100 Ωcm through 107 Ωcm, such as amorphous silicon and the like. The dielectric layer 40 is made mainly of silica (SiO₂). A metal electrode such as the gate electrode 45 is formed by depositing chrome (Cr) and patterning the resulting layer. When the gate electrode 45 is patterned, a gate hole 45A corresponding to an emitter is formed in the gate electrode 45.

Referring to FIG. 18B, a second dielectric layer 50 and a deflection electrode 55 are formed on the gate electrode 45. The deflection electrode 55 is patterned to be symmetrically divided into two parts with the emitter between them and to have different voltages.

Referring to FIG. 18C, the second dielectric layer 50 and the first dielectric layer 40 are etched, and a photoresist sacrifice layer is formed on an upper surface of the deflection electrode 55 and on an inner surface of an emitter hole. Thereafter, a predetermined portion of a cathode is exposed by removing the first dielectric layer in the hole through a back-side exposure. At this time, a resistive element formed of amorphous silicon enables the cathode to be selectively exposed.

Referring to FIG. 18D, a carbon nanotube emitter 100 is formed on a cathode 20 exposed at the bottom of the hole. Also, the carbon nanotube emitter 100 may be formed by coating carbon nanotube paste on an inner surface of the hole and then performing an UV exposure and a firing process on the resulting structure.

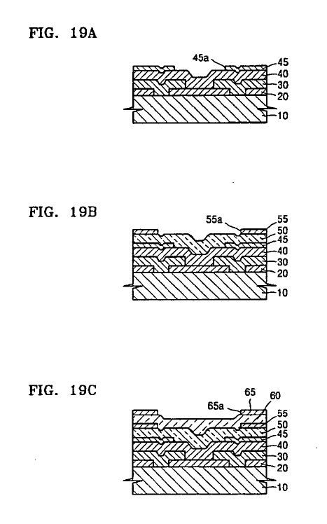

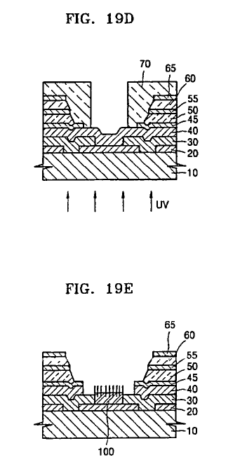

FIGS. 19A through 19E are sectional views illustrating a manufacturing procedure for a field emission display equipped with a deflection electrode and a protective electrode according to the present invention. The manufacturing procedure in FIGS. 19A through 19E is generally the same as that in FIGS. 18A through 18D. When compared with the manufacturing procedure in FIGS. 18A through 18D, the manufacturing procedure in FIGS. 19A through 19E further includes forming a third dielectric layer 60 and a protective electrode 65A on the deflection electrode 55. The protective electrode 65 is formed in a body with respect to a whole surface of the rear substrate, and a hole 65A corresponding to an emitter is formed through a patterning process. The hole 65A preferably has a round shape.

While the present invention has been particularly shown and described with reference to exemplary embodiments thereof, it will be understood by those of ordinary skill in the art that various changes in form and details may be made therein without departing from the spirit and scope of the present invention as defined by the following claims.

[Effect of the Invention]

As stated above, the direction of the electron beam can be controlled with a relatively-low voltage by providing the deflection electrode capable of controlling the direction of the electron beam on the rear substrate. Also, a possible misalignment between the front substrate and the rear substrate during a packaging process can be corrected through a simple method of uniformly adjusting a voltage applied to the deflection electrode.

Further, a sufficient data line width can be obtained even in a high-resolution device because emitters are in 1:1 correspondence with pixels, and a sufficient luminance can be obtained by applying a high voltage because a voltage of the anode need not be switched.

Furthermore, the cold cathode device on the rear substrate can be protected from charged particles generated in the display through a high voltage by providing a protective electrode formed in a body with respect to a whole surface of an uppermost layer of the rear substrate, whereby the lifetime and reliability of the field emission display can be improved.

1. A field emission display, comprising:
a rear substrate;
a cathode arranged on the rear substrate;
an emitter arranged on the cathode;
a first dielectric layer arranged on the cathode, a first through hole corresponding to the emitter being arranged in the first dielectric layer;
a gate electrode arranged on the first dielectric layer, a gate aperture corresponding to the emitter being arranged in the gate electrode;
a second dielectric layer arranged on the gate electrode, a second through hole corresponding to the emitter being arranged in the second dielectric layer; and
a deflection electrode arranged on the second dielectric layer, the deflection electrode having at least two elements symmetrically arranged to face each other with the emitter therebetween, the deflection electrode being configured to guide an electron beam emanating from the emitter to different subpixels by varying a difference in electric potential applied between a first of the two elements and a second of the two elements.

2. The display of claim 1, wherein the two elements are electrically isolated from each other and are adapted to be held at electric potentials that are different from each other at any point in time.

3. The display of claim 1, wherein the second through hole is arranged to have a round shape and the two elements of the deflection electrode comprise facing arc portions arranged at inner sides thereof.

4. The display of claim 1, wherein the deflection electrode comprises facing straight lines passing by both sides of the second through hole.

5. The display of claim 1, further comprising a resistive element arranged between the cathode and the emitter, the resistive element being configured to enable electrons to be transferred from the cathode uniformly to all parts of the emitter.

6. A field emission display, comprising:
a rear substrate;
a cathode arranged on the rear substrate in parallel stripes;
an emitter arranged on the cathode and spaced apart from the cathode;
a first dielectric layer arranged on the cathode, a first through hole corresponding to the emitter being arranged in the first dielectric layer;
a gate electrode arranged on the first dielectric layer in parallel stripes intersecting the parallel stripes of the cathode, a gate aperture corresponding to the emitter being arranged in the gate electrode;
a second dielectric layer arranged on the gate electrode, a second through hole corresponding to the emitter being arranged in the second dielectric layer;
a deflection electrode arranged on the second dielectric layer intersecting the gate electrode and extending in parallel with the cathode, the deflection electrode having at least two elements symmetrically arranged to face each other with the emitter therebetween;
a third dielectric layer arranged on the deflection electrode, a third through hole corresponding to the emitter being arranged in the third dielectric layer; and
a protective electrode arranged on the third dielectric layer, the protective electrode having a hole corresponding to the emitter.

7. The display of claim 6, wherein the protective electrode is arranged in a body with respect to an entire surface of the rear substrate.

8. The display of claim 6, wherein the second through hole is arranged to have a round shape and the two elements of the deflection electrode comprise facing arc portions arranged at inner sides thereof.

9. The display of claim 6, wherein the deflection electrode comprises facing straight lines passing by both sides of the second through hole.

10. The display of claim 6, further comprising a resistive element arranged between the cathode and the emitter and being configured to enable electrons to be transferred from the cathode uniformly to all parts of the emitter.

11. A field emission display, comprising:
a rear substrate;
a cathode arranged on the rear substrate;
an emitter arranged on the cathode;
a first dielectric layer arranged on the cathode, a first through hole corresponding to the emitter being arranged in the first dielectric layer;
a gate electrode arranged on the first dielectric layer, a gate aperture corresponding to the emitter being arranged in the gate electrode;
a second dielectric layer arranged on the gate electrode, a second through hole corresponding to the emitter being arranged in the second dielectric layer; a deflection electrode arranged on the second dielectric layer, the deflection electrode having at least two elements symmetrically arranged to face each other with the emitter therebetween; and
a deflection voltage controlling unit configured to cause an electron beam emanating from the emitter to deflect to different subpixels at different points in time by varying a difference in voltages applied between the two elements at a corresponding different points in time.

12. The display of claim 11, wherein the one of the subpixels corresponds to an electron beam not deflected by the deflection electrode.

13. The display of claim 11, wherein the second through hole is arranged to have a round shape and the two elements of the deflection electrode comprise facing arc portions arranged at inner sides thereof.

14. The display of claim 11, wherein the deflection electrode comprises facing straight lines passing by both sides of the second through hole.

15. The display of claim 11, further comprising a resistive element arranged between the cathode and the emitter and being configured to enable electrons to be transferred from the cathode uniformly to all parts of the emitter.

16. The display of claim 11, wherein the deflection electrode comprises a first element and a second element, the deflection voltage controlling unit being configured to apply voltages of three deflection modes, the three deflection modes comprise a R deflection mode where a voltage of the first element of the deflection electrode is lower than a voltage of the second element of the deflection electrode, a G deflection mode where a voltage of the first element of the deflection electrode is identical to a voltage of the second element of the deflection electrode, and a B deflection mode where a voltage of the first element of the deflection electrode is higher than a voltage of the second element of the deflection electrode.

17. The display of claim 16, the deflection voltage controlling unit is configured to sequentially apply voltage of the three deflection modes during each frame period.

18. The display of claim 1 1, the deflection voltage controlling unit is configured to horizontally shift arrival locations of electron beams by uniformly adjusting a voltage of one of at least the two elements of the deflection electrode with respect to all the deflection modes.

19. A field emission display, comprising:
a rear substrate;
a cathode arranged on the rear substrate;
an emitter arranged on the cathode;
a first dielectric layer arranged on the cathode, a first through hole corresponding to the emitter being arranged in the first dielectric layer;
a gate electrode arranged on the first dielectric layer, a gate aperture corresponding to the emitter being arranged in the gate electrode;
a second dielectric layer arranged on the gate electrode, a second through hole corresponding to the emitter being arranged in the second dielectric layer;
a deflection electrode arranged on the second dielectric layer, the deflection electrode having at least two elements symmetrically arranged to face each other with the emitter therebetween;
a third dielectric layer arranged on the deflection electrode, a third through hole corresponding to the emitter being arranged in the third dielectric layer;
a protective electrode arranged on the third dielectric layer, the protective electrode having a hole corresponding to the emitter; and
a deflection voltage controlling unit configured to apply voltages of several deflection modes to the deflection electrode to cause an electron beam emanating from the emitter to deflect to different subpixels at different points in time by varying a difference in voltages applied between the two elements at a corresponding different points in time.

20. The display of claim 19, wherein the second through hole is arranged to have a round shape and the two elements of the deflection electrode comprises facing arc portions arranged at inner sides thereof.

21. The display of claim 19, wherein the deflection electrode is arranged to have facing straight lines passing by both sides of the second through hole.

22. The display of claim 19, further comprising a resistive element arranged between the cathode and the emitter, the resistive element being configured to enable electrons to be transferred from the cathode uniformly to all parts of the emitter.

23. The plasma display of claim 19, wherein the deflection electrode comprises a first element and a second element, the deflection voltage controlling unit being configured to apply voltages of three deflection modes, the three deflection modes comprise a R deflection mode where a voltage of the first element of the deflection electrode is lower than a voltage of the second element of the deflection electrode, a G deflection mode where a voltage of the first element of the deflection electrode is identical to a voltage of the second element of the deflection electrode, and a B deflection mode where a voltage of the first element of the deflection electrode is higher than a voltage of the second element of the deflection electrode.

24. The display of claim 23, wherein the deflection voltage controlling unit is configured to sequentially apply voltage of the three deflection modes during each frame period.

25. The display of claim 19, wherein the deflection voltage controlling unit is configured to horizontally shift arrival locations of electron beams by uniformly adjusting a voltage of one of at least the two elements of the deflection electrode with respect to all the deflection modes.

26. A method of manufacturing a field emission display, comprising:
forming a cathode of a predetermined pattern on a rear substrate;
depositing sequentialy a resistor layer, a first dielectric layer and a first metal layer on the cathode;
patterning the first metal layer to form a gate electrode;
depositing sequentially a second dielectric layer and a second metal layer on the gate electrode;
patterning the second metal layer to from a deflection electrode;
forming an emiter aperture using an etching process exposing a portion of the cathode; and
forming an emitter on the exposed portion of the cathode, the emitter comprises a carbon nanotube.

27. A method of manufacturing a field emission display, comprising:
forming a cathode of a predetermined pattern on a rear substrate;
depositing sequentialy a resistor layer, a first dielectric layer and a first metal layer on the cathode;
patterning the first metal layer to form a gate electrode;
depositing sequentially a second dielectric layer and a second metal layer on the gate electrode;
patterning the second metal layer to from a deflection electrode;
depositing sequentially a third dielectric layer and a third metal layer on the deflection electrode;
patterning the third metal layer to form a protective electrode;
forming an emitter aperture using an etching process exposing a portion of the cathode; and
forming an emitter on the exposed portion of the cathode, the emitter comprises a carbon nanotube.
